(19) United States
(12) Patent Application Publication
(10) Pub. No.: US 2013/0188839 A1
(43) Pub. Date: Jul. 25, 2013

(54) METHOD AND DEVICE FOR DETERMINING WHEEL AND BODY MOTIONS OF A VEHICLE

(71) Applicants: Steffen Abraham, Hildesheim (DE); Axel Wendt, Stuttgart (DE); Winfrid Ziemlich, Stuttgart (DE); Michael Klar, Bad Friedrichshall (DE)

(72) Inventors: Steffen Abraham, Hildesheim (DE); Axel Wendt, Stuttgart (DE); Winfrid Ziemlich, Stuttgart (DE); Michael Klar, Bad Friedrichshall (DE)

(21) Appl. No.: 13/814,199

(22) PCT Filed: Jul. 18, 2011
(86) PCT No.: PCT/EP2011/062247

§ 371 Date: Apr. 10, 2013

(30) Foreign Application Priority Data
Aug. 4, 2010 (DE) 10 2010 038 905.6

(51) Int. Cl. G06K 9/00

(52) U.S. Cl. CPC G06K 9/00785
USPC 382/104

(57) ABSTRACT

A method for determining wheel and body motions of a vehicle having a body and at least one wheel includes inducing a motion of the vehicle, recording an image sequence of the moving vehicle, determining the optical flow from the recorded image sequence, and determining the position of at least one wheel center, the motion of the body and/or a damping ratio of the vehicle from the optical flow.

### FIELD

The present invention relates to a method and a device for determining wheel and body motions of a vehicle, in particular, a method and a device for testing shock absorbers with the aid of video image sequences of a passing vehicle.

### BACKGROUND INFORMATION

European Patent No. EP 0 611 960 B1 and German Patent No. DE 43 05 048 A1 describe methods for testing a shock absorber of a motor vehicle. In the methods, a motor vehicle wheel standing up on a wheel contact surface is set into vibrations by base-point excitation vibrations. The damping action of the vibration damper situated in the wheel suspension of the motor vehicle may be determined by relating the differences of the motion amplitudes and the velocities of motion of the wheel and those of the vehicle body to the acceleration of the wheel or the dynamic normal force, and by estimating the damping coefficient from this relationship. To test the quality of the vibration damper, the estimated damping coefficient is compared to a reference value, and it is determined if a deviation from the reference value lies within the tolerance band range.

European Patent No. EP 1 224 449 B1 and German Patent Application No. DE 10 2008 002 484 A1 describe the optical measurement of centers of wheels and body motions, as well as evaluations of them, in order to determine the damping ratio for characterizing the shock absorber, with the aid of, e.g., the single-mass resonator model (SMR), from the data of a passing vehicle set into vibration.

### SUMMARY

An object of the present invention is to provide an improved method for measuring wheel and body motions of a vehicle, as well as a device for implementing such a method.

An example method in accordance with the present invention for determining wheel and body motions of a vehicle includes the steps: inducing a motion of the vehicle; recording an image sequence of the moving vehicle that includes several images; determining the optical flow from the images of the recorded image sequence; and determining the position of at least one center of a wheel, the motion of the body and/or a damping ratio of the vehicle from the optical flow.

The present invention also includes a measuring device for determining wheel and body motions of a vehicle, the measuring device including at least one camera that is configured to record an image sequence of the vehicle, a computation device that is configured to calculate the optical flow from the recorded image sequence, and an evaluation device that is configured to determine the position of at least one wheel center, the motion of the body and/or the damping ratio from the optical flow.

The evaluation of the optical flow according to the present invention allows an evaluation from the motion of image features alone and eliminates the need for any modeling of the image content, such as a circular edge of a wheel rim or the axially symmetric shape of the wheel. It is robust and may be used for a multitude of different vehicle types. Consequently, it is particularly suitable for practical application in workshops, where a large variability of the vehicles to be tested is to be expected.

In one specific example embodiment, the position of at least one wheel center, the motion of the body and the damping ratio are determined simultaneously. By simultaneously determining the wheel and body motion, as well as the damping ratio, the method is the best possible damping determination from the data of the video camera, since no intermediate variables are derived, but the observations (in this case, the optical flow) are functionally related to the unknowns (in this case, the vibrational model, e.g., single-mass vibration system (SMR). Due to the regularization, the method is robust with regard to measuring errors in the image sequence; and in the method, systematic errors in the determination of the damping ratio are prevented to a large extent.

In one specific example embodiment, the method includes the step of eliminating geometric distortions in the recorded images (elimination of geometric distortion). An advantage of the elimination of geometric distortion is the considerable simplification of the mathematical modeling for the method for evaluating the optical flow. The elimination of geometric distortion is comparable to elimination of front-wall distortion known, e.g., in photogrammetry; see, for example, Thomas Luhmann, “Nahbereichsphotogrammetrie, Grundlagen—Methoden-Anwendungen [Short-Range Photogrammetry, Basics, Methods, Applications],” 2nd Edition, 586 pages, 2003.

In one specific embodiment of the method, the flow field is segmented from the determination of the optical flow. Such segmentation simplifies the following evaluation of the flow field.

In one specific example embodiment of the method, the segmenting includes segmenting the flow field into flow vectors on the wheel, flow vectors on the body, and flow vectors that are situated neither on the wheel, nor on the body. Such segmentation of the flow field has proved to be particularly advantageous for the following evaluation.

In one specific example embodiment of the method, the evaluating of the flow field includes the use of a Gauss-Markov model according to the method of least squares (see, e.g., W. Niemeier: “Ausgleichungsrechnung [Curve Fitting],” de Gruyter, Berlin-New York, 2002, ISBN 3-11-014080-2). The Gauss-Markov model allows an effective and accurate evaluation of the flow field.

In one specific example embodiment, the device includes at least a mono camera, a stereo camera or a multi-camera system. A device having a mono camera is particularly cost-effective; a device having a stereo camera or multi-camera system allows the parameters to be determined particularly accurately.

In one specific example embodiment, the measuring device includes at least one device that is suitable for inducing a motion of the vehicle. Using such an excitation device, the motion of the vehicle necessary for executing the method of the present invention may be induced in a particularly simple and reproducible manner.

In one specific embodiment, the measuring device is configured in such a manner, that the recording of images is carried out synchronously by several cameras and an expanded vehicle model is used for evaluating the recorded image sequences. In this manner, the accuracy of the parameter determination may be increased even further.

In the following, the present invention is explained in greater detail in light of the figures.

### BRIEF DESCRIPTION OF THE DRAWINGS

FIG. 1 shows a schematic view of an example measuring system of the present invention, including a vehicle.

FIG. 2 shows a block diagram of a vibration model.

FIG. 3 schematically shows the processing of the video image data recorded by one of the measuring cameras, in an example method of the present invention.

FIGS. 4a, 4b and 4c show the segmenting of the flow vectors.

FIG. 5 shows an evaluation model for simultaneously determining the wheel centers and the body motions.

### DETAILED DESCRIPTION OF EXAMPLE EMBODIMENTS

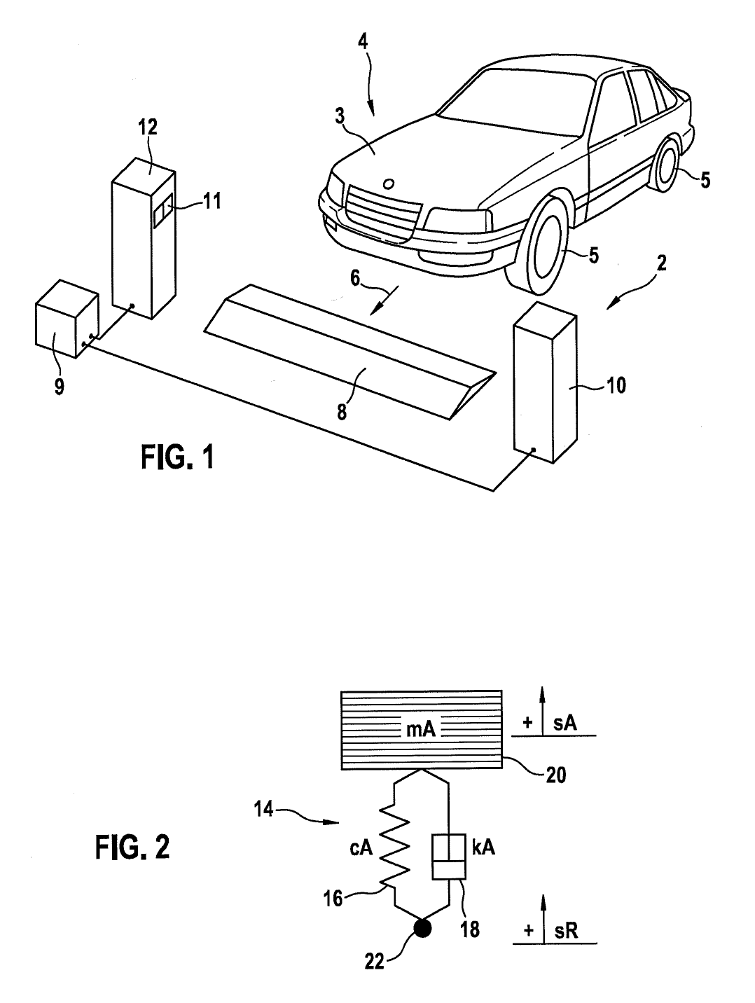

FIG. 1 shows a schematic view of a measuring system 2 according to the present invention, including a vehicle 4 whose vibration dampers are to be tested according to the present invention.

Measuring system 2 includes an elongated threshold having a defined height, the main direction of extension of the threshold being situated essentially perpendicular to, i.e., at generally a right angle to, moving direction 6 of vehicle 4. The length of threshold 8 corresponds to at least the width of vehicle 4, so that upon traveling over threshold 8, two wheels 5 of the same axle of vehicle 4 each undergo a specific vertical excitation from threshold 8 and are set into a vertical vibration.

In each instance, a left measuring head 10 and a right measuring head 12 are situated on the two sides of threshold 8, either at the level of threshold 8 or just behind threshold 8 in the direction of travel of vehicle 4. Each of the measuring heads has at least one measuring camera 11, which is pointed inwards in the direction of vehicle 4 and includes, e.g., CCD sensors. Measuring cameras 11 are mounted at a suitable height above the ground and are capable of optically monitoring wheel 5 and body 3 of vehicle 4. In a method of the present invention, a number of images, which form an image sequence, are recorded by each of the measuring cameras 11, while vehicle 4 travels over threshold 8.

Measuring system 2 also has a data processing unit 9, which receives the image sequences recorded by measuring cameras 11 of measuring heads 10 and 12 and is set up to execute an evaluation method of the present invention.

Measuring system 2 may also include the option of inputting data, by which data for the vehicle 4 to be tested is able to be input either manually via a connected keyboard, or via a data linkage to another computer, or by reading it in from a storage medium.

FIG. 2 shows a block diagram of a vibration model 14. Vibration model 14 is a displacement-induced, single-mass vibration system (SMR), by which the vibration between body 3 and motor vehicle wheel 5 is able to be described. Vibration model 14 represents an analysis of a quarter of a vehicle, i.e., one side of an axle including the proportional body mass mA.

Vehicle mass or body mass mA is denoted by reference numeral 20 and is schematically represented as a rectangle. Wheel axle 22 or the wheel suspension is denoted by reference numeral 22. The vibration damper is formed by the spring 16 having spring constant cA, and by parallel damping element 18 having damping factor kA; and body mass 20 is supported on wheel axle 22 by this vibration damper.

The direction of motion of vehicle wheel 5, or wheel motion sR, is represented by an arrow pointing upwards, and the direction of motion of body mass 3, or body motion sA, is likewise represented by an upwardly pointing arrow.

Due to the motion of vehicle wheel 5 and the transmission through the vibration damper, body mass 20 is set into vibration.

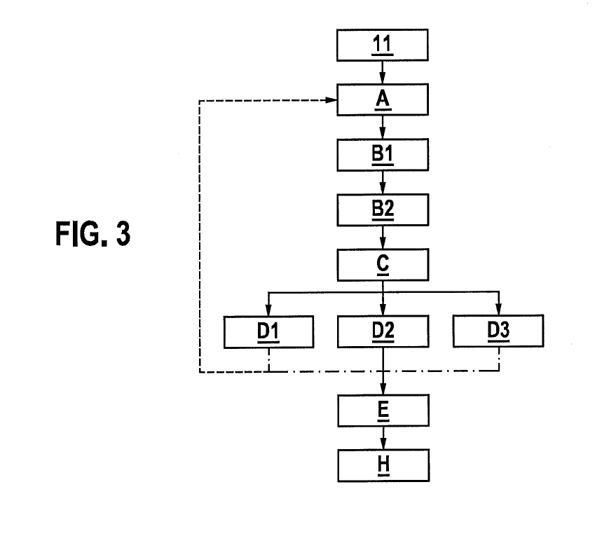

FIG. 3 schematically describes the processing of the video image data recorded by one of the measuring cameras 11, in an example method of the present invention:

Starting out from a mono video camera 11, recorded image sequence A is transferred to dedicated computer hardware for image rectification B1. The image rectification is necessary for simplified modeling of the functional models. If the input image data are not rectified, then the optical distortion, which is caused by the recording optics, etc., is also applied arithmetically to the ascertained flow field. The image rectification is a standard method, which is also used, for example, in the calculation of stereo video images.

Subsequently, the optical flow is likewise determined on dedicated computer hardware B2, from the rectified image data. The fundamental principles for calculating the optical flow are described, for example, by Berthold K. P. Horn and Brian G. Schunck in “Determining Optical Flow,” Artificial Intelligence, vol. 17, no. 1-3, pp. 185-203, 1981. The real-time processing of the optical flow based, e.g., on a FPGA is described, for example, by Zhaoyi Wei, Dah-Jye Lee and Brent E. Nelson in “FPGA-based Real-time Optical Flow Algorithm Design and Implementation,” Journal of Multimedia, Vol. 2, No. 5, September 2007, pages 38-44. A vector field between, in each instance, two consecutive images is calculated from the mono video image data. This corresponds to the determination of the correspondences of points and indicates the moving direction and speed of these points.

In the next step C, the flow field is segmented into flow vectors D1 on vehicle body 3, flow vectors D2 on wheel 5 and flow vectors D3, which are situated neither on vehicle body 3, nor on wheel 5. The vectors of the two groups D1 and D2 differ in that the motion of body 3 only includes translational components, and the motion of wheel 5 includes a combination of angular motion and translational components due to the rolling motion.

In this context, the segmentation obeys the following rules:

All vectors, which include an angular and translational motion that occurs at the highest frequency in the vector field, are classified as wheel vectors D2. All vectors, which only include a translational motion that occurs at the highest frequency in the vector field, are classified as body vectors D1.

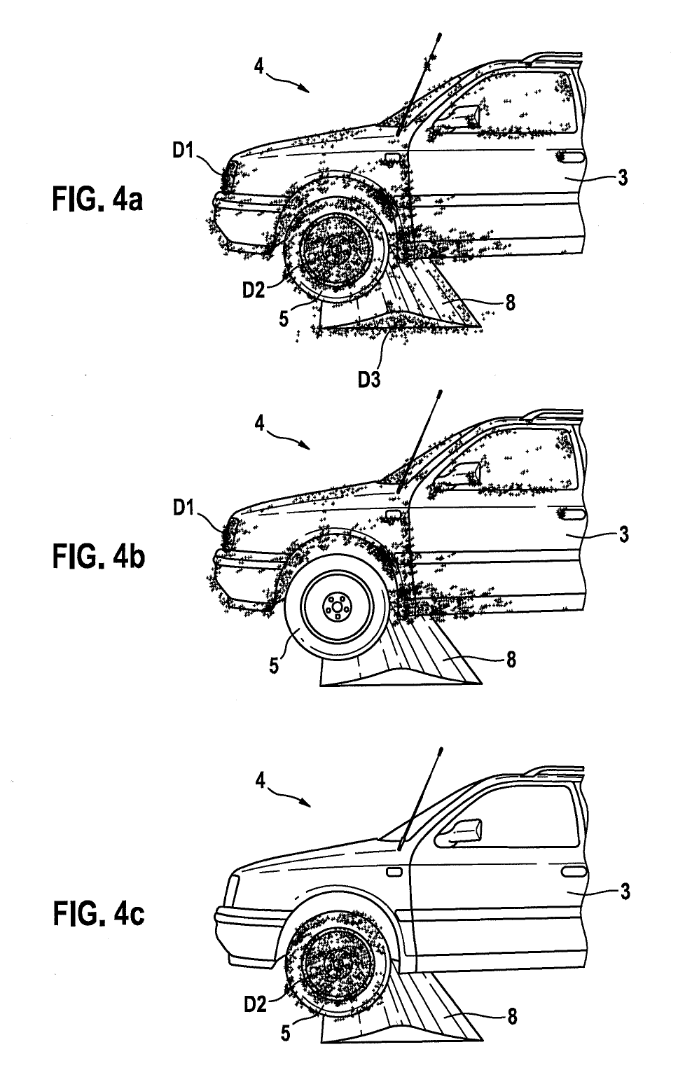

FIGS. 4a through 4c show, by way of example, a side view of vehicle 4, including flow vectors D1, D2 and D3 determined from the recorded image sequence. In this context, flow vectors D1, D2 and D3 are illustrated as crosses in the schematic, graphical representation. All of the flow vectors D1, D2, D3 are shown in FIG. 4a. In FIG. 4b, only the flow vectors D1 that have been assigned to body 3 during the segmentation are shown, and in FIG. 4c, only the flow vectors D2 that have been assigned to wheel 5 during the segmentation are shown.

If all images of the recorded sequence of the vehicle 4 set into vibration have been processed, then parameters H, inter alia, the sought-after damping parameter, are determined in evaluation model E. In this context, the segmented flow fields D1, D2, D3 are used as input data.

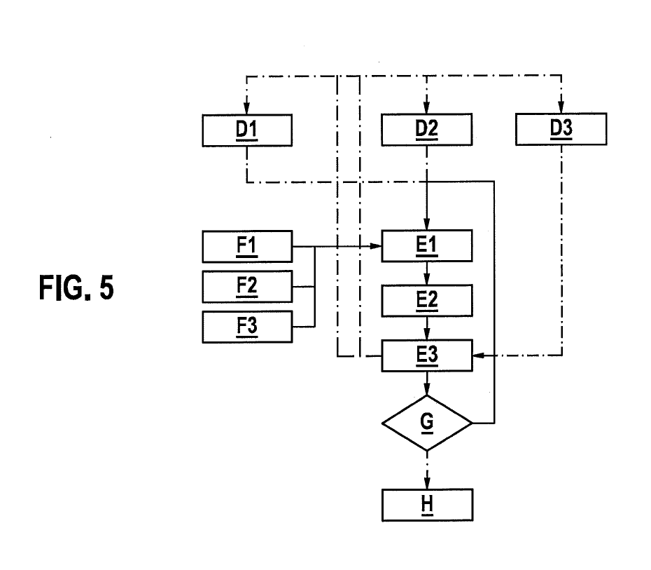

An evaluation model for simultaneously determining the wheel centers and the body motions of all of the video-sequence times to be considered, as well as for determining the damping ratio that is explained below in further detail, is illustrated in FIG. 5.

The solution is found in a Gauss-Markov model, according to the method of least squares. In step E1, a normal system of equations is set up. Functional model F1 is used for flow vectors D1 of vehicle body 3, and functional model F2 is used for flow vectors D2 of wheel 5.

Vibration equation F3 is introduced as a conditional equation between the unknown variables of functional models F1, F2. It has a regularizing effect and leads to the determination of the sought-after damping ratio.

In step E2, the normal system of equations is solved. In E3, the starting segmentation is revised, using the parameters determined in step E2: In light of the parameters now determined in an improved manner, it is checked if vectors from the flow vectors D3, which, until now, have not been assigned to either the body or the wheel, actually lie in one of these regions. In an inverse determination, it is also checked if the vectors currently classified as D1 or D2 are correctly assigned. The revised segmentation results are used iteratively in E1 for setting up the normal system of equations. This operation is repeated until the convergence of the curve-fitting operation is ascertained in G. The parameters H finally determined are the sought-after solution.

The previously determined flow vectors

D1: u_{Ai}=[u_{Axi}, u_{Ayi}] of body points (P_{Ai}); and
D2: u_{Ri}=[u_{Rxi}, u_{Ryi}] of wheel points (Pᵣᵢ)
are available for the evaluation.
The following parameters are to be determined:
damping ratio Θ;
center of rotation Zᵢ for each time i of the image sequence; and
a fixed reference point on the body T_{Ai}, whose motion over the image sequence is determined. It is used for determining the spring oscillation of the wheel.

### Functional Models:

1. Measuring equation of the body points F1:

[u_{Axi},u_{Ayi}]=P_{Ai-1},Tᵢ,Tᵢ₋₁) (1)

where Pₐᵢ₋₁ is a body point in image i−1, from which the flow u_{Axi}, u_{Ayi} results, and Tᵢ, Tᵢ₋₁ is the reference point on the body at time i and i−1, respectively.

### 2. Measuring Equation of the Body Points F2:

[u_{Rxi},u_{Ryi}]=F₂(Δαᵢ,P_{Ri-1},Dᵢ,Dᵢ₋₁) (2)

where the following variables are
P_{Ri-1} a wheel point in image i−1;
Dᵢ, Dᵢ₋₁ centers of rotation of the wheel at times i and i−1, respectively; and
Δαᵢ the differential roll angle of the wheel.

### 3. Vibration Equation, Single-Mass Resonator (F3)

If vehicle 4 travels parallel to the image plane, then body motion Z_{Ai} and wheel motion Z_{Ri} may be approximated in simplified terms as the motion in the z direction, in image coordinates, of the reference point on the body Tᵢ, and of the center of rotation Dᵢ. This assumes that the suspension acts perpendicularly to the direction of travel of vehicle 4. Since the damping coefficient only describes a decay of the vibration, a full-scale connection between the real world [mm] and the image coordinates [pixels] does not have to be established. The motion is just calculated directly in pixel coordinates.

The differential equation of the single-mass resonator is:

Z″_{Ai}+2δ(Z′_{Ai}−Z′_{Ri})+ω₀²(Z_{Ai}−Z_{Ri})=0 (3)

This yields, for the function F3:

F3(Z″_{Ai},Z′_{Ri},Z′_{Ai},Z_{Ri},Z_{Ai},δ,ω₀)=2δ(Z′_{Ai}−Z′_{Ri})+ω₀²(Z_{Ai}−Z_{Ri}) (4)

where the following variables denote:
ω₀ the natural frequency of the body;
δ a decay constant;

Z″_{Ai} the acceleration of the body in pixels/s²;

Z′_{Ai} the speed of the body in pixels/s;
Z′_{Ri} the speed of the wheel in pixels/s;
Z_{Ai} the position of the body in pixels; and
Z_{Ri} the position of the wheel in pixels.

The Lehr damping ratio used for assessing the vibration damper is defined as the quotient of the decay constant and the natural frequency of the body:

Θ=δ/ω0

The functional models in equations (1), (2) and (4) show how the flow vectors are in direct relation with the sought-after unknowns for determining damping ratio Θ. In addition, flow vectors, which solely describe the relationship between two images, suffice as input data. Thus, trajectories of points of features over the entire video sequence are not required, which means that the method may be implemented in a simple manner.

According to the method of least squares, the sum of the squares of the deviations of the functional models F1, F2, F3 simultaneously considered are minimized in order to determine the above-mentioned parameters. The solution is obtained according to standard methods of curve fitting, as are described, for example, by W. Niemeier in “Ausgleichungsrechnung [Curve Fitting],” de Gruyter, Berlin—New York 2002, ISBN 3-11-014080-2.

In one possible variant, several cameras, 4 on each side of the vehicle, are used. In this manner, a shorter distance between the measuring heads 10, 12 situated opposite to one another may be implemented. In order to obtain the same field of view, several cameras or measuring heads 10, 12 are then be installed laterally on each side of vehicle 4, along the direction of travel. The advantage is that a very narrow system layout is feasible, which is only slightly wider than the width of the vehicle. To evaluate several camera images per side, elimination of distortion is carried out, in each instance, on a common reference plane. The optical flow is subsequently calculated, and the above-described evaluation procedure is carried out.

In one variant, the method is executed without the step of image rectification. The optical flow vectors are calculated from the original, distorted video camera images. The flow vectors are subsequently corrected by the geometric distortion, or the distortion is taken into account in the functional model during the calculation of damping ratio (Θ). Depending on the density of the flow field or the number of flow vectors, this may result in an optimization of the computing time necessary for the execution of the method.

Optionally, the functional modeling may be expanded by parameters, which describe

a) a tilting of the image plane and the plane of motion of the vehicle;
b) changes in depth between individual wheel and body points; and/or
c) deviations from the perpendicular motion of the wheel suspension (oblique spring angle); in order to improve the accuracy of the method.

1-10. (canceled)

11. A method for determining wheel and body motions of a vehicle having a body and at least one wheel, the method comprising:
inducing a motion of the vehicle;
recording a sequence of images of the moving vehicle;
determining an optical flow from the recorded images of the image sequence; and
determining from the optical flow, at least one of: i) a position of at least one wheel center, ii) a motion of the body, and iii) a damping ratio of the vehicle.

12. The method as recited in claim 11, wherein the position of at least one wheel center, the motion of the body and the damping ratio are determined simultaneously.

13. The method as recited in claim 11, further comprising:
eliminating geometric distortions in the recorded images.

14. The method as recited in claim 11, wherein the determining of the optical flow includes segmenting a flow field.

15. The method as recited in claim 14, wherein the segmenting includes segmenting the flow field into flow vectors on the wheel, flow vectors on the body, and flow vectors that are situated neither on the wheel, nor on the body.

16. The method as recited in claim 14, wherein the determining includes using a Gauss-Markov model in accordance with least squares.

17. A measuring device for determining wheel and body motions of a vehicle, which has a body and at least one wheel, the measuring device comprising:
at least one camera configured to record a sequence of images of the vehicle;
a computation device configured to calculate an optical flow from the recorded image sequence; and
an evaluation device configured to determine from the optical flow at least one of: i) the position of at least one wheel center, ii) a motion of the body, and iii) a damping ratio.

18. The device as recited in claim 17, wherein the camera is one of a mono camera, a stereo camera, or a multi-camera system.

19. The device as recited in claim 17, further comprising:
at least one device suitable for inducing a motion of the vehicle.

20. The device as recited in claim 17, wherein the device is configured in such a manner that the recording of images is carried out synchronously by several cameras and an expanded vehicle model is used for evaluating the recorded image sequences.
